(19) United States
(12) Patent Application Publication
(10) Pub. No.: US 2009/0027155 A1
(43) Pub. Date: Jan. 29, 2009

(54) Fuse

(76) Inventors: Hiroo Arikawa, Tokyo (JP); Koh Ishimura, Nasushiobara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/219,267

(22) Filed: Jul. 18, 2008

(30) Foreign Application Priority Data
Jul. 26, 2007 (JP) 194480/2007

(51) Int. Cl. H01H 85/165

(52) U.S. Cl. 337/228

(57) ABSTRACT

A small-sized fuse is provided that has a large breaking capability and is easy to manufacture. When a fusible element 18 melts and turns into metal vapor, arc discharge occurs in a large space 40 across which the fusible element 18 extends, of an inner space 26, and a pressure in the large space 40 rises instantaneously to an extremely large degree. Due to this pressure rise, the breaking member 24 moves from a position shown in FIG. 5A to a position shown in FIG. 5B. With the movement of the breaking member 24, the breaking member 24 closes instantaneously link holes 36 and 38 in a main body, whereby a flow of electrons is interrupted and the arc discharge is extinguished instantaneously.

### BACKGROUND OF THE INVENTION

1. Field of the Invention

The present invention relates to a fuse and, in particular, a fuse that can be used to protect a battery unit for use in automobiles, emergency power sources or the like, and has a structure suited for a fuse with a rated DC voltage of 800V or less and a rated interrupting current of 5,000 A or less.

2. Prior Art

A fusible element of a conventional fuse with a rated DC voltage of 800V or less and a rated interrupting current of 5,000 A or less used for protection of a main circuit in a battery unit, has generally a structure in which an elongated plate-shaped element called a plate-element or a ribbon-element has narrow portions with holes or constrictions at several sites. The battery unit supplies a relatively large current, and thus if a short circuit occurs, a current of several thousand amperes is passed to turn the fusible element into metal vapor and generate arc discharge. An arc-extinguishing material is filled around the fusible element for prompt extinguishment of arc discharge.

There already exists a current-limiting fuse with a structure as aforementioned in which a main body is a two-part split structure for simplification of an assembly process, as disclosed in Japanese Patent Application Public-disclosure No. 2004-119105.

For example, there also exists a current-limiting fuse that is manufactured by the following manufacturing process, as disclosed in Japanese Patent Application Public-disclosure No. 2002-329456: an arc-extinguishing material is filled into a concave portion of a die (one of dies); a fusible element is placed thereon; an arc-extinguishing material is further filled thereinto; and a punch (the other of the dies) is used to press and mold the arc-extinguishing material in the shape of a rectangle (cuboid). The arc-extinguishing material is mixed with a liquid binder as a kind of adhesive before being filled, and the arc-extinguishing material mixed with a liquid binder is filled. An adhesive that loses its adhesive properties at high temperatures is used in a vicinity close to the fusible element, and an adhesive that completely coagulates at high temperatures is used in a vicinity relatively far from the fusible element. After molding, the arc-extinguishing material is subjected to a sintering process. Specifically, it is heat-treated around its circumference at a high temperature to form an uncured arc-extinguishing material portion around the fusible element, and to form a cured arc-extinguishing material portion, that is, a main body, around the uncured arc-extinguishing material portion. However, this manufacturing process is complicated, and a strength of the main body and a state of the arc-extinguishing material portion around the fusible element depend on a kind, quantity and mixing state of an arc-extinguishing material and binder used, a sintering process, and the like. This causes a disadvantage in that it is difficult to manufacture highly reliable products.

Therefore, generally used is a current-limiting fuse in which a fusible element is stored in an inner space of a fuse main body and an arc-extinguishing material is filled around the fusible element. For filling the arc-extinguishing material into the fuse main body, it is necessary to dispose the fusible element inside the columnar main body and then fill the arc-extinguishing material from outside the main body such that the arc-extinguishing material accumulates in the inner space of the fuse main body. If the fuse main body has a two-part split structure, it is necessary to fill the arc-extinguishing material after the two parts are joined together.

For filling the arc-extinguishing material into the inner space of the fuse main body, it is necessary to insert the arc-extinguishing material little by little from a through hole connecting to the inner space of the fuse main body, without damaging the fusible element, and then check to see if the arc-extinguishing material has been filled without any clearance being left. Therefore, a disadvantage exists in an amount of time and labor involved in filling the arc-extinguishing material, and consequent low production rate of fuses.

In a fuse with a fusible element that has narrow portions with holes or constrictions formed at several sites of a plate-shaped element, only the narrow portions melt and sever at a time of operation with a small excess current, but the overall fusible element turns into metal vapor when a large excess current is to be interrupted. Therefore, there is a disadvantage in that higher-density metal vapor is generated as compared with a case of using an electric-wire-like fusible element, which makes it difficult to extinguish arc discharge.

Further, for the plate-shaped element with narrow portions, the element is thin, and portions with holes or constrictions are narrow. These narrow portions have a low mechanical strength. Every time an excess current flows, the fusible element is repeatedly subjected to thermal expansion and cooling shrinkage, and mechanical metal fatigue is concentrated on narrow portions with small cross-sectional areas, as a result of which the portions easily crack and melt.

For a fusible element referred to as either a plate-element or a ribbon-element, due to the element's sheet design, it is necessary to provide a relatively large inner space in the main body in which the fusible element is received, thereby preventing a reduction in size of the fuse.

### SUMMARY OF THE INVENTION

An object of the present invention is to provide a small-sized fuse which overcomes the foregoing disadvantages, has a large breaking capability, and is easy to manufacture.

In accordance with the aforementioned object, there is provided a fuse comprising: a fusible element; a pair of conductive terminals; a main body formed of a heat-resistant insulating material; and a breaking member, wherein said main body is shaped in a column, has an inner space provided in a central part of the column, and has open spaces provided on both ends of the column, and has a pair of link holes for linking between said inner space and said open spaces; said fusible element extends across said inner space through said link holes; said breaking member is disposed in said inner space; said pair of conductive terminals are mounted in said open spaces and electrically and mechanically connected to both ends of the fusible element; and said breaking member splits said inner space into a large space and a small space such that said fusible element extends across said inner space, and said fusible element extends across only said large space; whereby when a large excess current flows through said fuse to turn said fusible element into metal vapor to cause arc discharge, a pressure rise in said large space at the time of occurrence of arc discharge causes said breaking member to be moved from said large space toward said small space so that said breaking member closes said link holes.

The main body may have two split case members that are split along a direction linking each end thereof. The two split case members may have concave portions that form the inner space when the two split case members are joined together. At least one split case member may have a notch in a split surface of the split case member so as to form the open spaces and the link holes when the two split case members are joined together.

The fusible element may extend across the large part of the inner space, in a straight line or in the form of an inverted U. In the case of extension across in the shape of an inverted U, a breaking member 24 may be provided with a barrier 124.

For example, when a fuse is used to protect a main circuit of a battery unit in an automobile or an emergency power supply as aforementioned and a large excess current such as a short-circuit current flows through the fuse due to a failure in the battery unit or the main circuit, a fusible element 18 instantaneously melts and turns into metal vapor. In a fuse of the present invention, when the fusible element 18 has turned into metal vapor as stated above, arc discharge occurs in a large space 40 across which the fusible element 18 extends, of an inner space 26, and also a pressure in the large space 40 rises instantaneously to an extremely large degree. Due to this pressure rise, the breaking member 24 moves to cause a small space 42 of the inner space 26 to virtually disappear. The movement of the breaking member 24 closes the link holes instantaneously, whereby a flow of electrons is interrupted and the arc discharge is extinguished instantaneously.

If the breaking member 24 is provided with the barrier 124 and a central part of the fusible element 18 is formed in the shape of an inverted U, it is impossible to form an arc discharge path that connects the link holes 36 and 38 in a straight line, and thus the discharge path is extended to bypass the barrier, which facilitates extinguishment of arc discharge.

### BRIEF DESCRIPTION OF THE DRAWINGS

FIG. 1 is an exploded view of a fuse according to a preferred first embodiment of the present invention;

FIG. 2 is a completion view of the fuse shown in FIG. 1;

FIG. 3 is a cross-sectional view of the fuse shown in FIG. 2 as taken along X-X′;

FIG. 4 is a view of an upper case shown in FIG. 1 as seen from the underside;

FIG. 5A is a view showing an inner state of the fuse shown in FIG. 1 before operation;

FIG. 5B is a view showing an inner state of the fuse shown in FIG. 1 after operation; and

FIG. 6 is a view showing a modification of a breaking member 24 shown in FIG. 1.

### DETAILED DESCRIPTION OF THE PREFERRED EMBODIMENTS

A preferred embodiment of the present invention will now be described below with reference to the drawings. Throughout the drawings, like reference numerals denote like or similar components.

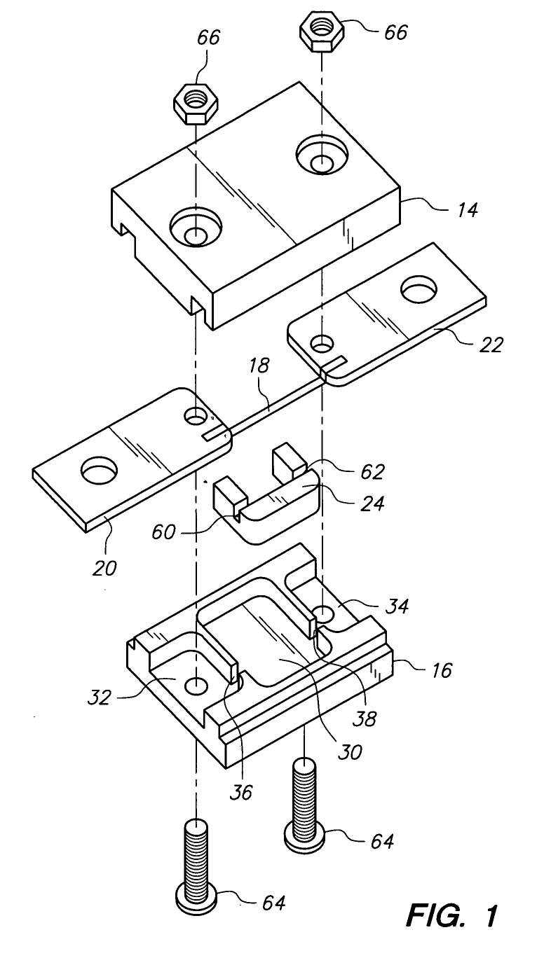

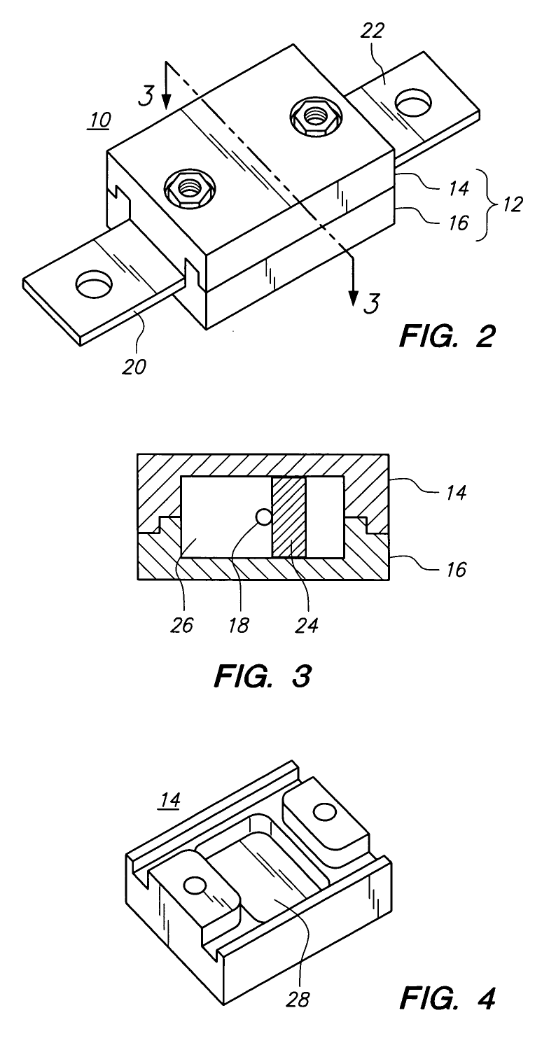

FIG. 1 is an exploded view of a fuse according to a preferred first embodiment of the present invention, FIG. 2 is a completion view thereof, FIG. 3 is a cross-sectional view of FIG. 2 as taken along X-X′, and FIG. 4 is a view of an upper case as seen from the underside.

As shown in FIGS. 1 and 2, a fuse 10 comprises a main body 12 composed of an upper case 14 and a lower case 16, a fusible element 18, a pair of conductive terminals 20 and 22, and a breaking member 24.

The upper case 14, the lower case 16 and the breaking member 24 are made from a heat-resistant insulating material such as thermosetting resin. Although, in this embodiment the upper case 14, the lower case 16 and the breaking member 24 are made from the same material, the material of the cases 14 and 16 may be different from that of the breaking member 24.

The fusible element 18 has a linear shape, and both ends thereof are electrically and mechanically connected to the pair of conductive terminals 20 and 22.

In the present invention, the main body 12 (the upper and lower cases 14 and 16), the fusible element 18, the conductive terminals 20 and 22, and the breaking member 24 may be made from any material suitable for the purpose of application, and the present invention is not limited to any particular kind of material. In addition, electrical and mechanical connection between the fusible element 18 and the conductive terminals 20 and 22 may be made by any appropriate method.

The upper case 14 has a concave portion 28 (refer to FIG. 4) and the lower case 16 has a concave portion 30 so that an inner space 26 is formed inside the main body 12 when the upper and lower cases 14 and 16 are joined together as shown in FIG. 2. Concave portions 32 and 34 are formed at both ends of the lower case 16 along a longer side thereof to form open spaces into which the conductive terminals 20 and 22 are fitted. In addition, notches 36 and 38 are formed between the concave portions 32 and 34 and the concave portion 30, through which the fusible element 18 passes. The notches 36 and 38 form holes through which the fusible element 18 passes when the upper and lower cases 14 and 16 are joined together, and hereinafter they are also called link holes, as appropriate.

The breaking member 24 separates the inner space 26 of the main body 12 into a large closed space and a small closed space. The breaking member 24 is slightly shorter than the side of the inner space 26 which is parallel to the longer side of the fuse 10 so that the breaking member can move in the inner space 26. In addition, the breaking member 24 is slightly smaller in height than the inner space 26 as shown in FIG. 3. The breaking member 24 moves from the large space toward the small space to close the link holes 36 and 38 (refer to FIG. 1). The breaking member 24 is provided with notches 60 and 62 through which the fusible element 18 passes.

The aforementioned components are assembled as follows: the breaking member 24 is placed into the concave portion 30 of the lower case 16; in this placement, the breaking member 24 needs to be positioned in the concave portion 30 so that the fusible element 18 passes through the notches 60 and 62 in the breaking member 24 when the fusible element 18 extends across the concave portion 30 of the lower case 16; the conductive terminals 20 and 22 connected with the fusible element 18 are fitted into the concave portions 32 and 34 of the lower case 16, respectively. When the conductive terminals 20 and 22 are fitted into the concave portions 32 and 34, both ends of the fusible element 18 are engaged with the notches 36 and 38, the middle part of the fusible element 18 extends across the concave portion 30 through the notches 60 and 62; the upper case 14 and the lower case 16 are combined so as to form the inner space 26; the upper and lower cases 14 and 16 and the conductive terminals 20 and 22 are fastened with use of screws 64 and nuts 66, as shown in FIG. 1, to complete the fuse 10, as shown in FIG. 2. The present invention is not limited by fastening with screws 64 and nuts 66, and any appropriate fastening method may be used including adhesive bonding.

Since the foregoing components and their assembly of the fuse 10 are as described above, it is easy to manufacture the fuse 10. Further, in the sense that no arc-extinguishing material is used, the present invention is apparently easier to manufacture as compared to a fuse using an arc-extinguishing material.

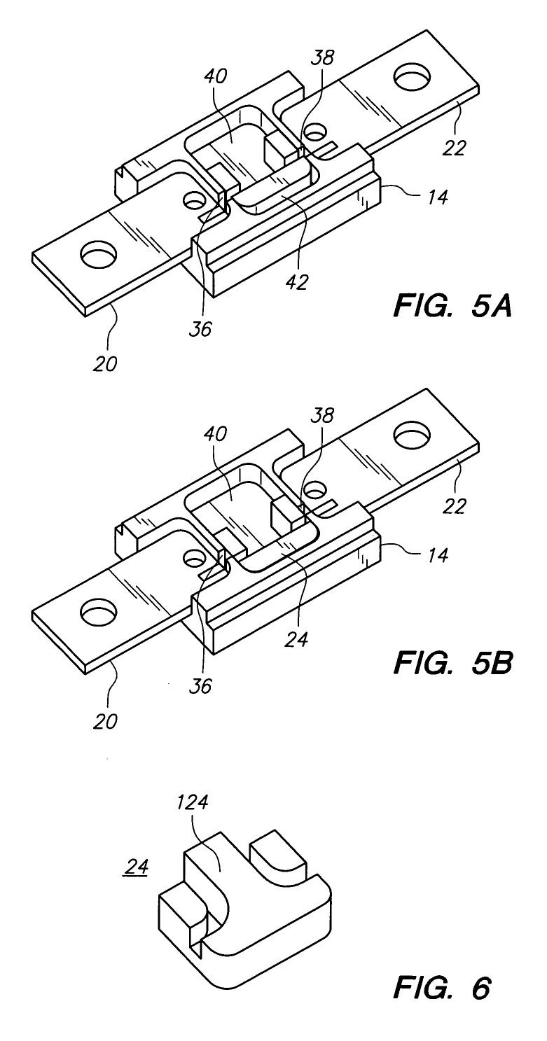

Next, an operation of the thus assembled fuse 10 will be described. FIGS. 5A and 5B are views showing inside states of the fuse before and after the operation: FIG. 5A shows a state before the operation; and FIG. 5B shows a state after the operation. In the state before the operation of the fuse 10 shown in FIG. 5A, when the fuse 10 is used to protect a main circuit of a battery unit in an automobile or an emergency power supply as stated above, for example, and a large excess current such as a short-circuit current flows through the fuse 10 due to a failure in the battery unit or main circuit, the fusible element 18 instantaneously melts and turns into metal vapor. When the fusible element 18 turns into metal vapor as above, arc discharge occurs in the large space 40 across which the fusible element 18 extends, of the inner space 26, and at the same time, a pressure in the large space 40 rises to an extremely large degree instantaneously. Due to this pressure rise, the breaking member 24 moves to change the inside state as shown in FIG. 5B. Movement of the breaking member 24 closes instantaneously the link holes 36 and 38 of the main body 12, whereby a flow of electrons is interrupted and the arc discharge is extinguished instantaneously.

A fuse of the present invention operates as aforementioned and thus has a large breaking capability. In addition, a fuse of the present invention is of a self-extinguishing type with a simple structure, as stated above, and also does not use an arc-extinguishing material. As a result, the fuse of the present invention can be made smaller in size as compared to other types of fuses that have the same in rating as the fuse of the present invention.

FIG. 6 illustrates a modification of the breaking member 24 shown in FIG. 1. The breaking member is provided with a barrier 124. The fusible element extends in the shape of an inverted U across the inner space so as to bypass the barrier.

Although the fusible element 18 is described as a linear structure with regard to the foregoing embodiment, the fusible element 18 may be of a winding structure.

The invention has been described in detail with particular reference to certain preferred embodiments thereof, but it will be understood that variations and modifications can be effected within the spirit and scope of the invention.

What is claimed is:

1. A fuse comprising:
a fusible element;
a pair of conductive terminals;
a main body formed of a heat-resistant insulating material; and
a breaking member, and wherein
said main body is shaped in a column, has an inner space provided in a central part of the column and open spaces provided on both ends of the column, and has a pair of link holes for linking between said inner space and said open spaces;
said fusible element extends across said inner space through said link holes;
said breaking member is disposed in said inner space;
said pair of conductive terminals are mounted in said open spaces and electrically and mechanically connected to both ends of said fusible element; and
said breaking member splits said inner space into a large space and a small space such that said fusible element extends across said inner space and fusible element extends across only said large space; whereby
when a large excess current flows through said fuse to turn said fusible element into metal vapor to cause arc discharge, a pressure rise in said large space at the time of occurrence of arc discharge causes said breaking member to be moved from said large space toward said small space so that said breaking member closes said link holes.

2. The fuse according to claim 1, wherein
said main body has two split case members that are split along a direction linking each end thereof;
said two split case members have concave portions that form said inner space when said two split case members are joined together; and
at least one split case member has a notch in a split surface of the split case member so as to form said open spaces and said link holes when said two split case members are joined together.
